(19) United States
(12) Patent Application Publication
(10) Pub. No.: US 2009/0308624 A1
(43) Pub. Date: Dec. 17, 2009

(54) Screw tightening axial force control method using impact wrench

(76) Inventors: Ryoichi Shibata, Osaka (JP); Yoshiyuki Nakagawa, Osaka (JP)

Correspondence Address: PATRICK H. ALLEY;SQUIRREL LEAP,, HAGLEY ROAD,, FLEET, HANTS. GU13 8LH, ENGLAND, GB

(21) Appl. No.: 11/920,008

(22) PCT Filed: Aug. 28, 2007
(86) PCT No.: PCT/JP2007/066656

§ 371 Date: Nov. 7, 2007

(30) Foreign Application Priority Data
Sep. 5, 2006 (JP) 2006-240105
Aug. 13, 2007 (JP) 2007-210828

(51) Int. Cl. B25B 21/02; B25B 23/14

(52) U.S. Cl. 173/1; 173/176

(57) ABSTRACT

Conventionally, as screw tightening axial force control, there is a control method such as a torque control method. The torque control method requires estimation of a torque coefficient, and has a problem that a calculated axial force value is an estimated value. An object of the present invention is to provide a method for directly controlling an axial force by calculating the axial force generated by an impact force by using an impact wrench. A 45-degree slant line is set from an origin O of orthogonal coordinate axes to be used for screw tightening axial force control, an impact progress point Hᵢ generated by an i-th impact is detected on the 45-degree slant line, a length HSᵢ of a line segment OHᵢ is read, and an axial force value Fᵢ after the i-th impact occurs is calculated by using the formula Fᵢ=HSᵢ×cos 45°. Another method for controlling the axial force by using impact information is also disclosed.

### TECHNICAL FIELD

The present invention focuses on use of impact information generated at the time of impact in screw tightening using an impact wrench, and relates to a method for controlling an axial force value of a screw tightening body.

### BACKGROUND ART

A first object of screw tightening control is to provide a tightening body which does not exceed a lower limit of a set axial force of a tightening body design and does not exceed an upper limit thereof. However, under the present circumstances, existence of a technique for realizing this has not been disclosed.

At present, as known screw tightening axial force control methods, except for special methods, three methods including a conditional torque control method stipulated in “general rules for tightening of threaded fasteners” of JIS B1083 as mainstream, an angle control method, and a torque gradient control method have been proposed. However, in actuality, the only method that has spread in practical use is the torque control method.

In the angle control method, standardization of an execution method thereof has not been developed yet, and development of devices has not been observed yet. The torque gradient control method has a problem in equipment, and general adoption thereof has not been developed yet.

Even in the spread torque control method, although the tightening torque value can be controlled, control of the tightening axial force has not grown to a reliable control method under the present circumstances except for a part of places of work. The reason for this is that the torque and the axial force are in proportion to each other, however, the torque coefficient as a proportional constant is calculated by using a friction coefficient of tightening surfaces as a main element. At the present time, it is impossible to know a true value of the friction coefficient at the time of tightening of a tightening body.

Therefore, it is stipulated that the torque control method should be performed under a condition that a torque coefficient of a tightening body is known and controlled. Therefore, the reliability of control by the torque control method is confined to a screw tightening work place complete with a torque coefficient control system.

In conclusion, under the present circumstances, execution of reliable screw tightening axial force control is impossible except for screw tightening by the torque control method under a torque coefficient maintaining control system or screw tightening using also an ultrasonic bolt axial force meter.

Development of machine civilization has not stopped, and securing of safety thereof is most important. One of the important objects that have become the foundation for safety is the development of a screw tightening axial force control method which is high in reliability and is easily carried out.

Development of axial force control of static screw tightening (screw tightening by static force) is now in a stagnant state, and the inventors decided to search for the possibility by experimentation in screw tightening axial force control using an electromechanical impact wrench.

Conventionally, the impact wrench was evaluated as lacking controllability, and this was regarded as its worst weakness. The inventors conducted a series of experiments by using an electromechanical impact wrench, measured a screw tightening axial force generated by an impact force and impact information (axial force control impact information) produced from the impact force, performed required processing, and considered the relevance between these. As a result, it was found that the relevance between the impact information that a sensor on the impact wrench side could collect and the axial force was sufficiently significant and accurate.

The behavior of the screw tightening axial force control by an impact wrench is composed of instantaneous coupling (within 1/1000 seconds) and energy transmission between the impact wrench side and a screw tightened material side, and a third party cannot take part in this. That is, the tightening behavior involves independence and isolation. This makes a reaction force very small, and enables a tightening work with a high torque by hand holding.

The instantaneous characteristics of impact can be read by digital measurement, and enables tightening with an accurate axial force value conformable to the reality of a tightening force which the present invention aims at.

That is, the impact phenomenon simultaneously generates necessary data, and the data is provided as accomplished facts. The characteristics of the impact force include a part that is not conformable to deductive understanding, and requires inductive understanding.

(Description of Impact Information)

Data shown by the series of experiments is generation of a screw axial force of an impact and 10 pieces of impact information simultaneously generated described in the following (1) through (10).
(1) Input energy (E): Impact energy applied to a screw tightening body according to impact action of an impact wrench. It is calculated from angular velocities of an impact rotor before and after the impacting and inertia moment. Unit: [J]
(2) Dynamic torque (T): Torque to be applied to a screw tightening body according to impact action of an impact wrench. This is calculated from an impact angular acceleration (deceleration) of an impact rotor and inertia moment. Unit: [N·m]
(3) Screw rotation angle (total) (A): Sum of a screw rotation angle (elongation) (a) and a screw rotation angle (contraction). Unit: [degree]

A screw rotation angle (elongation) is a rotation angle of a screw system caused by elongation of the screw system.

A screw rotation angle (contraction) is a rotation angle of a screw system caused by contraction of a tightened material.

Herein, the screw system means a system obtained by combining a bolt and a nut or a female screw in place of a nut.
(4) Intersection Pᵢ coordinates (pₓᵢ, p_{yi}): Coordinates of an intersection Pᵢ of a 45-degree slant line provided on a coordinate plane of an orthogonal coordinate system used and an impact line.
(5) Measurement time (t): Elapsed time from a screw tightening start time. Unit: [cs] where “cs” means centisecond ( 1/100 second).
(6) Forward rotation time (t′): Time obtained by subtracting a rebound time from the measurement time. Unit: [cs]
(7) Forward rotation time ratio (r): (Forward rotation time)/(Measurement time)
(8) Impact point (M): Position detected on the X axis for each impact. An impact line passing this impact point parallel to the vertical axis can be drawn.
(9) Rebound angle (R): Angle of rebound of a rotating cylindrical member (impact rotor) after the impact action of the impact wrench. Unit: (degree)

Herein, the rotating cylindrical member means a member which is rotated by a motor and applies an impact force to a driven shaft (anvil) side.
(10) Ordinal number of pulse: Pulse signal shown in Detailed Description of the Invention described later and FIG. 3. Based on a detected pulse signal, input energy, a screw rotation angle (total), a measurement time, a forward rotation time, etc., can be calculated.

Formulas for calculating the respective information are as follows.

E=½×I×((ωₘ)²−(ωₙ)²)

T=I×(ωₘ−ωₙ)/|tₘ−tₙ|

A=360×((elongated length of screw system)+(contracted length of tightened material))/(screw pitch)

Herein, I, ωₘ, ωₙ, tₘ, and tₙ denote as follows:
I: value obtained by totalizing inertia moments of a rotating cylindrical member and a rotor of an impact wrench as shown in FIG. 1
ωₘ: Angular velocity immediately before the rotating cylindrical member shown in FIG. 13(a) and FIG. 13(b) applies an impact to the driven shaft.
ωₙ: Valley value of the angular velocity after the rotating cylindrical member shown in FIG. 13(a) and FIG. 13(b) applies an impact on the driven shaft. When rebound occurs, ωₙ=0.
tₘ: Measurement time when the angular velocity of the rotating cylindrical member shown in FIG. 13(a) and FIG. 13(b) is ωₘ.
tₙ: Measurement time when the angular velocity of the rotating cylindrical member shown in FIG. 13(a) and FIG. 13(b) is ωₙ.

The input energy (E), the screw rotation angle (total) (A), the measurement time (t), the forward rotation time (t′), and the axial force (F) show values accumulated since the screw tightening start time. The dynamic torque (T), the intersection Pᵢ coordinates (pₓᵢ, p_{yi}), and the rebound angle (R) show values of each impact. In the screw tightening by using an impact wrench, impacts are intermittently generated, so that the impact order from the time of the first rebounding is shown by a subscript i.

Furthermore, the output energy E₀ described in Claim 7 is energy that the screw tightening body receives according to impact action of an impact wrench, and shows a value accumulated since the screw tightening start time. Unit: [J]

A formula for calculating the output energy is as follows:

E₀=½×C×K×a².

Herein, C, K, and a show respectively as follows:
C: Expressed as C=(screw pitch)/360, and is a conversion coefficient according to use of a rotation angle (degree) for the screw rotation angle (elongation) (a) as a deformation amount of the screw system.
K: Called “spring constant of screw” and expressed as K=(axial force)/(screw rotation angle (elongation)), and is a ratio of an axial force [kN] applied to the screw system to the screw rotation angle (elongation) [degree].

### (1) Coordinate Axes to be Used

Coordinate axes to be used in Claims 1 through 7 are composed of a horizontal axis of a coordinate plane of an orthogonal coordinate system on which (kN) as units showing an axial force is calibrated, and a vertical axis on which the time (cs), rotation angle (degree), energy (J), and torque (N·m) as units showing axial force control impact information are calibrated, wherein unit lengths of the horizontal axis and the vertical axis are set equal to each other.

### (2) 45-Degree Slant Line

A straight line that passes through the origin of the coordinate axes to be used and has a deflection angle of 45 degrees with respect to the horizontal axis is called a 45-degree slant line, and is for obtaining a ratio of an axial force to impact information. The unit lengths of the horizontal axis and the vertical axis are set equal to each other, so that the values of the X coordinate and Y coordinate of a point on the 45-degree slant line become equal to each other.

This is application of working of the tightening triangular diagram of screw tightening shown in the following (4) as the principle of screw tightening to impact tightening, and shows that energy outputted from the screw side of the screw tightening body and energy received by the tightened material are equal to each other.

By this 45-degree slant line, a right-angled isosceles triangle composed of the origin of the coordinate axes to be used, the impact point, and the intersection P, is formed.

By using this right-angled isosceles triangle, in axial force control, normal tightening or abnormal tightening (eccentricity, deformation of the screw system or the tightened material, and foreign matter biting, etc.) can be judged, and it becomes possible to secure the quality of screw tightening and realize convenience of the work. The 45-degree slant line must be further studied across industries in the future.

### (3) Spring Constant Deflection Angle Line (α Line) of Screw

A straight line that passes through the origin of coordinate axes used and has a deflection angle α with respect to the horizontal axis is called a spring constant deflection angle line or α line of the screw. α=tan⁻¹ ((screw rotation angle (elongation)/axial force)), and this deflection angle α is called a spring constant deflection angle of the screw.

### (4) Tightening Triangular Diagram of Screw Tightening

The tightening triangular diagram of screw tightening (hereinafter, referred to as tightening triangle) is a basic principle of a mechanical structure of screw tightening. The reliability thereof is based on the fact that half of a tightening triangle is a spring constant of a screw. The spring constant of a screw is independent from screw tightening and is held by a bolt, etc.

Basically, an axial force value in axial force control of screw tightening is calculated by multiplying this constant by a screw rotation angle (elongation).

### (5) Impact Snag Point and Initial Non-Proportional Region

The impact snag point is a point to be acknowledged as a seating point of a tightening body in axial force control by impact tightening. A hammer member which strikes the driven shaft involves rebound from the point of seating, and from this point, impact axial force control can be started.

The point of strike number 1 in FIG. 9 and FIG. 10 corresponds to this. The period from the rebound start time to the rotation end time of the screw according to a next strike is regarded as one strike, so that the rebound angle generated by striking of the strike number 1 is described in the column of the strike number 2. The period from the screw tightening start to the impact snag point is called the initial non-proportional region, and in this region, stability of the screw tightening is low, so that description of data is omitted in FIG. 9 and FIG. 10.

### (6) Impact Information and Impact Line

On the coordinate axes to be used, both of detection of all impact information in each striking and detection of some of the impact information in the first quadrant are possible.

In both of these cases, detection points of impact information in the corresponding impact are all positioned on an impact line drawn parallel to the vertical axis from the impact point.

The impact time of an impact wrench is very short as described above, and an axial force and 10 pieces of impact information can be handled as simultaneous phenomena.

These pieces of information appear simultaneously and integrally with generation of an axial force. However, each piece of information has individual obvious value and individuality. They have no deductive relationship except for the forward rotation time ratio (r).

FIG. 5 shows the relationship among impact information positioned on an impact line L drawn from a certain impact point (M), an axial force, and a deflection angle by polar coordinates, and is regarded as an impact screw tightening basic plot. In this figure, it is observed that impact screw tightening and static screw tightening are clearly different in characteristics from each other.

Static screw tightening requires a deductive proportionality coefficient in a relational expression between tightening data and an axial force. On the other hand, values of impact screw tightening data are derived as a result of a natural phenomenon of an impact, and cannot allow artificial participation. Therefore, the impact axial force has the precision which the nature has.

The present invention uses characteristics of an impact force, uses no deductive control proportionality coefficient, and reads a screw tightening axial force, and is superior in accuracy, efficiency, and economic efficiency than existing control methods.

### DISCLOSURE OF THE INVENTION

According to a first aspect of the present invention as described in Claim 1, a screw tightening axial force control method using an impact wrench including the steps of:

setting a 45-degree slant line from an origin O of orthogonal coordinate axes to be used for calculating an axial force value;

detecting an impact progress point Hᵢ generated by an i-th impact on the 45-degree slant line;

reading a length HSᵢ of a line segment OHᵢ; and

calculating an axial force value Fᵢ after the i-th impact occurs according to the following formula:

Fᵢ=HSᵢ×cos 45°.

According to a second aspect of the present invention as described in Claim 2, a screw tightening axial force control method using an impact wrench including the steps of:

setting a 45-degree slant line from an origin O of orthogonal coordinate axes to be used for calculating an axial force value;

detecting an impact progress point Hᵢ generated by an i-th impact on the 45-degree slant line and reading an X coordinate value hₓᵢ of Hᵢ; and

calculating an axial force value Fᵢ after the i-th impact occurs according to the following formula:

Fᵢ=hₓᵢ.

According to a third aspect of the present invention as described in Claim 3, a screw tightening axial force control method using an impact wrench including the steps of:

setting a 45-degree slant line from the origin O of orthogonal coordinate axes to be used for calculating an axial value;

determining an impact line Lᵢ by using at least one of impact information generated by an i-th impact;

obtaining an intersection Pᵢ of the 45-degree slant line and the impact line and reading a length PSᵢ of a segment OPᵢ; and

calculating an axial force value Fᵢ after the i-th impact occurs according to the following formula:

Fᵢ=PSᵢ×cos 45°.

Herein, Fᵢ can also be expressed by the following formula although this is out of the scope of this Claim 3:

Fᵢ=PSᵢ×sin 45°.

According to a fourth aspect of the present invention as described in Claim 4, a screw tightening axial force control method using an impact wrench including the steps of:

setting a spring constant deflection angle line from an origin O of orthogonal coordinate axes to be used for calculating an axial force value and a 45-degree slant line;

determining an impact line Lᵢ by using at least one of impact information generated by an i-th impact;

obtaining an intersection Pᵢ of the 45-degree slant line and the impact line and reading the value pₓᵢ of the X coordinate thereof; and

calculating an axial force value Fᵢ after the i-th impact occurs according to the following formula:

Fᵢ=pₓᵢ×tan α×K

provided that α denotes a deflection angle between the spring constant deflection angle line of the screw and the horizontal axis, and
K denotes a spring constant of the screw expressed by (axial force)/(screw rotation angle (elongation)).

According to a fifth aspect of the present invention as described in Claim 5, a screw tightening axial force control method using an impact wrench including the steps of:

setting a spring constant deflection angle line from an origin O of orthogonal coordinate axes to be used for calculating an axial force value;

determining an impact line Lᵢ by using at least one of impact information generated by an i-th impact; and

reading a value gₓᵢ of an X coordinate and a value g_{yi} of a Y coordinate of a detection point Gᵢ concerning any one of detected impact information, where

a deflection angle θ_{gi} between a line segment connecting the origin O and the detection point Gᵢ and the horizontal axis can be expressed by the following formula:

θ_{gi}=tan⁻¹(g_{yi}/gₓᵢ)

and calculating an axial force value Fᵢ after the i-th impact occurs according to the following formula:

Fᵢ=g_{yi}/tan θ_{gi}

θ_{gi} can also be expressed by the following expression by reading the X coordinate value pₓᵢ of the intersection Pᵢ of the 45-degree slant line and the impact line although this is out of the scope of this claim, and

θ_{gi}=tan⁻¹(g_{yi}/pₓᵢ)

by using the thus obtained θ_{gi}, it is also possible to calculate the axial force value Fᵢ by the aforementioned formula.

According to a sixth aspect of the present invention as described in Claim 6, a screw tightening axial force control method using an impact wrench including the steps of:

setting a spring constant deflection angle line of a screw from an origin O of orthogonal coordinate axes to be used for calculating an axial force value;

determining an impact line Lᵢ by using at least one of impact information generated by the i-th impact:

reading a value gₓᵢ of an X coordinate of a detection point Gᵢ concerning any one of the detected impact information; and

calculating an axial force value Fᵢ after an i-th impact occurs according to the following formula:

Fᵢ=gₓᵢ×tan α×K.

According to a seventh aspect of the present invention as described in Claim 7, an elastic screw tightening control method using an impact wrench including the steps of:

setting a spring constant deflection angle line of a screw from an origin O of orthogonal coordinate axes;

determining an impact line Lᵢ by using at least one of impact information generated by the i-th impact;

obtaining an intersection Bᵢ of the spring constant deflection angle line of the screw and an impact line, and reading a value aᵢ of the Y coordinate thereof;

calculating output energy Eₒᵢ transmitted to a screw tightening body after the i-th impact occurs according to the following formula:

Eₒᵢ=½×C×K×(aᵢ)²

provided that C is a conversion coefficient expressed as (screw pitch)/360.

According to the first aspect of the present invention, to obtain an axial force value to be used for the screw tightening axial force control method, calculation is performed by using a coordinate plane of a so-called orthogonal coordinate system having a vertical axis and a horizontal axis that are orthogonal to each other on a two-dimensional plane.

Therefore, in the screw tightening axial force control method using an impact wrench, when an impact is generated a plurality of times by an impact wrench, impact information successively generated by the respective impacts are detected by a detecting means, and the detected i-th impact information is analyzed to obtain position information on the coordinate plane, and a point based on the obtained position information is set as an i-th impact progress point Hᵢ and positioned on the 45-degree slant line, and a length HSᵢ of a line segment OHᵢ connecting the origin O and the impact progress point Hᵢ is calculated or read, and based on the obtained length HSᵢ i, an axial force value Fᵢ after the i-th impact occurs is calculated according to a formula of Fᵢ=HSᵢ×cos 45°, and based on a result of comparison between the calculated axial force value Fᵢ and a target axial force value, the operation of the impact wrench is controlled, whereby the screw tightening axial force is controlled.

Therefore, the screw tightening axial force control method according to the first aspect can also be expressed as follows.

A screw tightening axial force control method using an impact wrench including the steps of:

to calculate an axial force value, by using a coordinate plane of an orthogonal coordinate system having a horizontal axis and a vertical axis that are orthogonal to each other,

setting a 45-degree slant line that passes through the origin O and has an inclination of 45 degrees on the coordinate plane;

when an impact is generated a plurality of times by the impact wrench,

detecting impact information generated by an i-th impact by a detecting means and positioning an i-th impact progress point Hᵢ on the 45-degree slant line based on the detected i-th impact information;

calculating or reading a length HSᵢ of a line segment OHᵢ connecting the origin O and the impact progress point Hᵢ; and

calculating an axial force value Fᵢ after the i-th impact occurs according to the following formula, wherein

by controlling operations of the impact wrench based on a result of comparison between the calculated axial force value Fᵢ and a target axial force value, the screw tightening axial force is controlled.

Fᵢ=HSᵢ×cos 45°

The present invention is the world's first full-scale screw tightening axial force control method as far as the inventors know. It can be said that this method is a solution for the variety of difficult problems which screw tightening has.

With the spread of a wrench and control device embodying the present invention, the tightening technique in the screw tightening field will be improved, and in both designing and tightening of screw tightening, screw tightening with a maximum axial force allowable for a bolt will be realized, and as a result, reduction in size and weight of a tightening body will be realized, and resource saving, energy saving, and power saving will be realized worldwide.

In addition, all types of equipment are improved in safety. In the case of wrenches, reduction in weight, power saving, and reduction in vibration and noise of wrenches are realized. An optimum combination of a wrench to be used and a tightening work and an exclusive wrench can be realized.

Numerical targets in the existing screw tightening methods, the torque control method, the angle control method, the torque gradient control method, and plastic range tightening are realized, and their reliabilities are improved.

As an effect of the present invention, the interest and enlightenment on striking power are increased from an engineering standpoint. Conventionally, the striking power was not conformable with calculation formulas of static engineering, and was regarded as an uncontrollable rough existence. However, as shown in the present invention, the striking power and digital measurement are compatible with each other in some regards and have accuracy, so that these will bring about a development effect in the future of equipment industries.

### BRIEF DESCRIPTION OF THE DRAWINGS

FIG. 1 is a construction view of an impact wrench to be used for a screw tightening axial force control method of the present invention;

FIG. 2 is a sectional view of a main portion of FIG. 1;

FIG. 3 is a diagram showing waveforms of pulse signals outputted from detection sensors;

FIG. 4 is a common explanatory view of Claims 4 through 7;

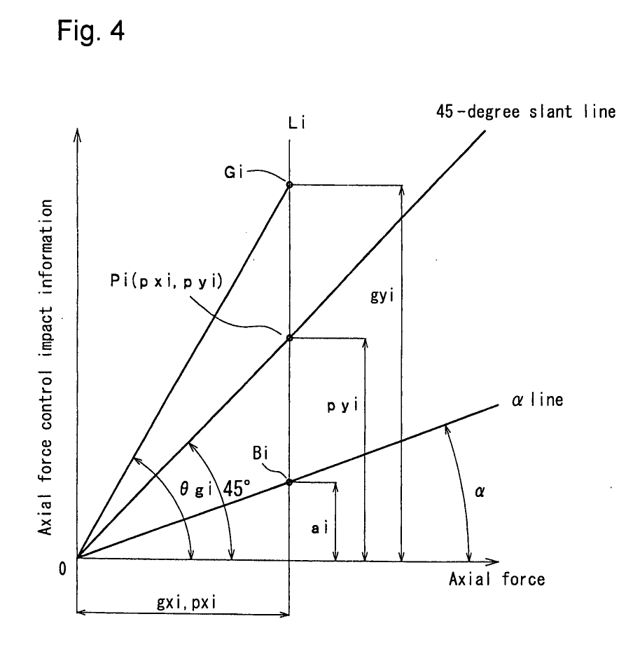

FIG. 5 is a screw tightening basic chart according to an impact;

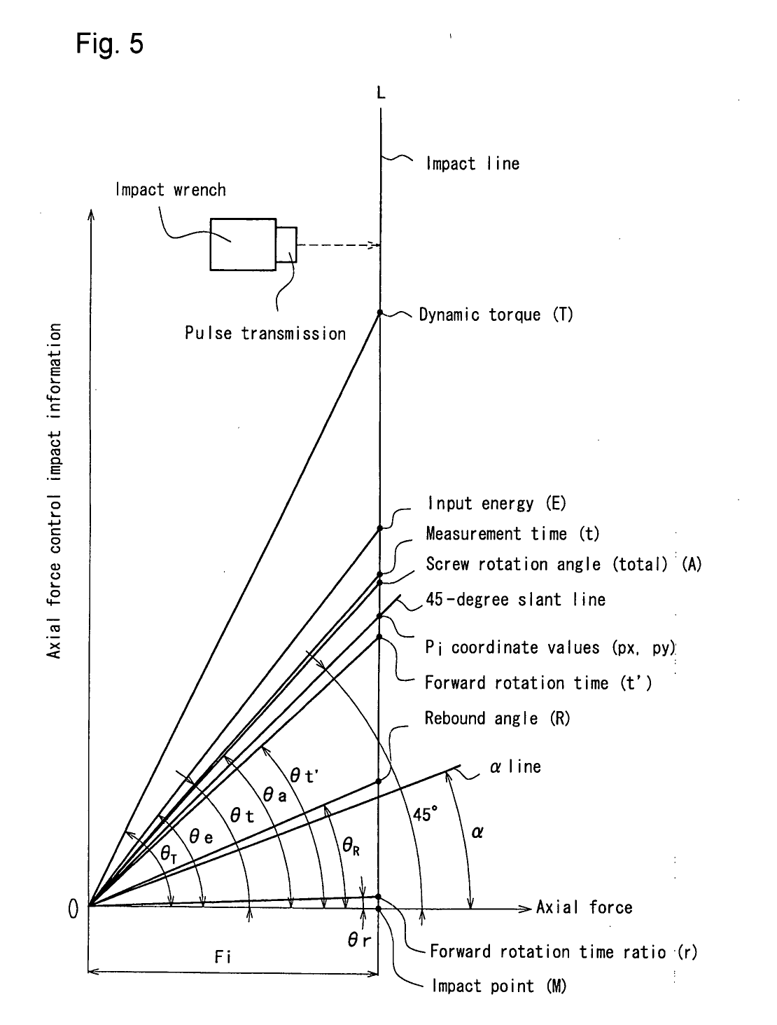

FIG. 6 is a screw tightening structure view by using an impact wrench, and is an explanatory view common to Claims 1 and 2;

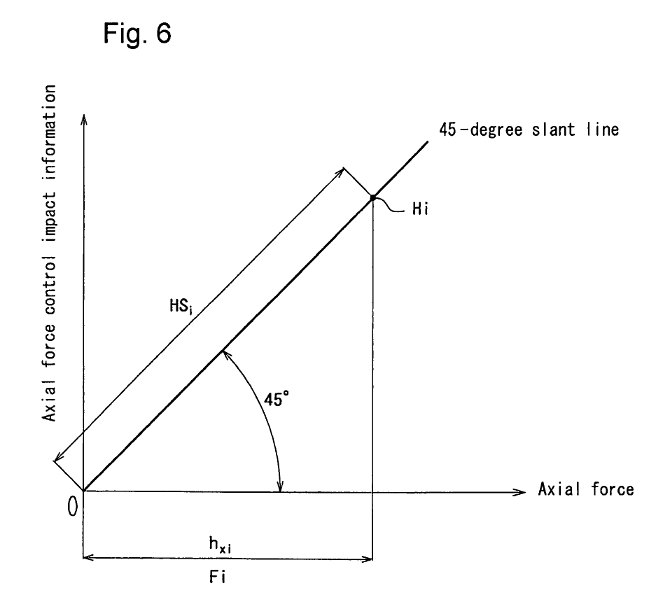

FIG. 7 is a screw tightening structure view by using an impact wrench, and is an explanatory view common to Claims 3 and 4;

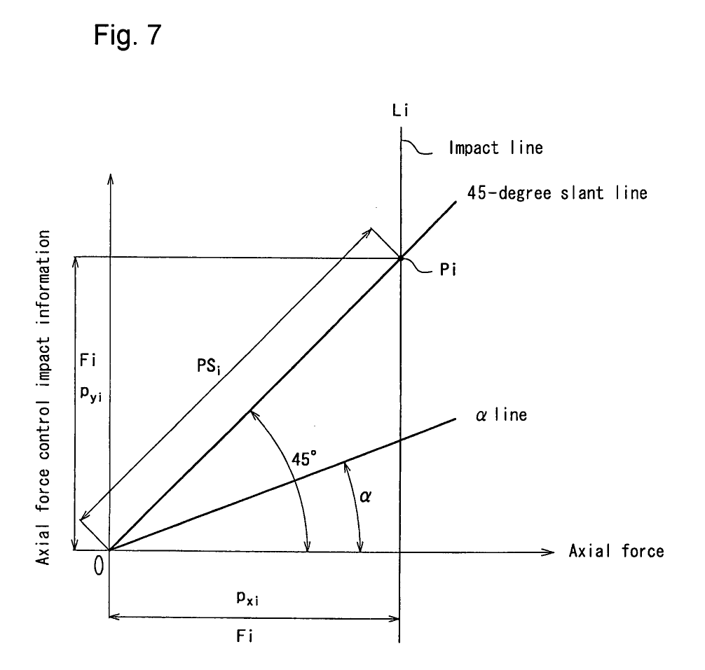

FIG. 8 is an explanatory view of a sample tightening body;

FIG. 9 is a data table at the time of tightening when the bolt and nut of Example 1 are brand new;

FIG. 10 is a data table at the time of the third tightening of the bolt and nut of Example 2;

FIG. 11 is an explanatory view at the time of tightening when the bolt and nut of Example 1 are brand new;

FIG. 12 is an explanatory view at the time of the third tightening of the bolt and nut of Example 2; and

FIG. 13 is an explanatory view showing relationships between a measurement time and an angular velocity of the rotating cylindrical member in conjunction with rebound and without rebound.

### DETAILED DESCRIPTION OF THE INVENTION

An axial force control method using an impact wrench according to the present invention will be described in detail with reference to the drawings showing an embodiment.

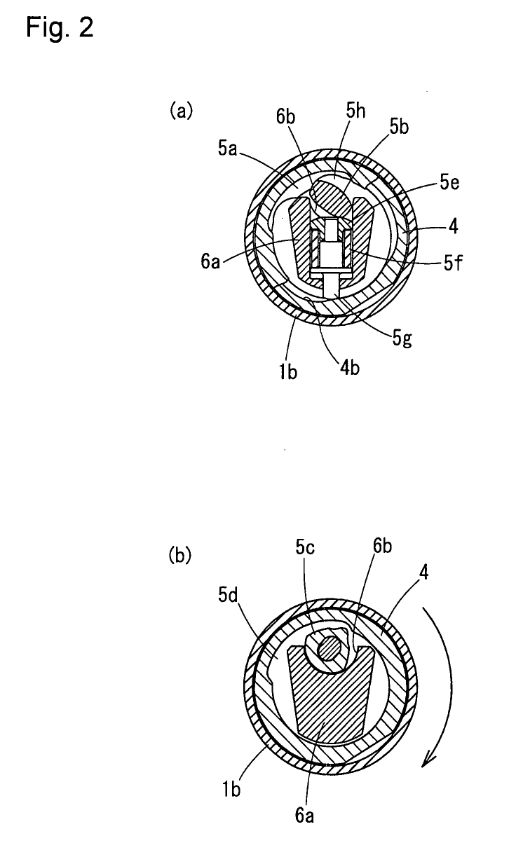

An example of an impact wrench to be used in the present invention is described in FIG. 2(a) and FIG. 2(b).

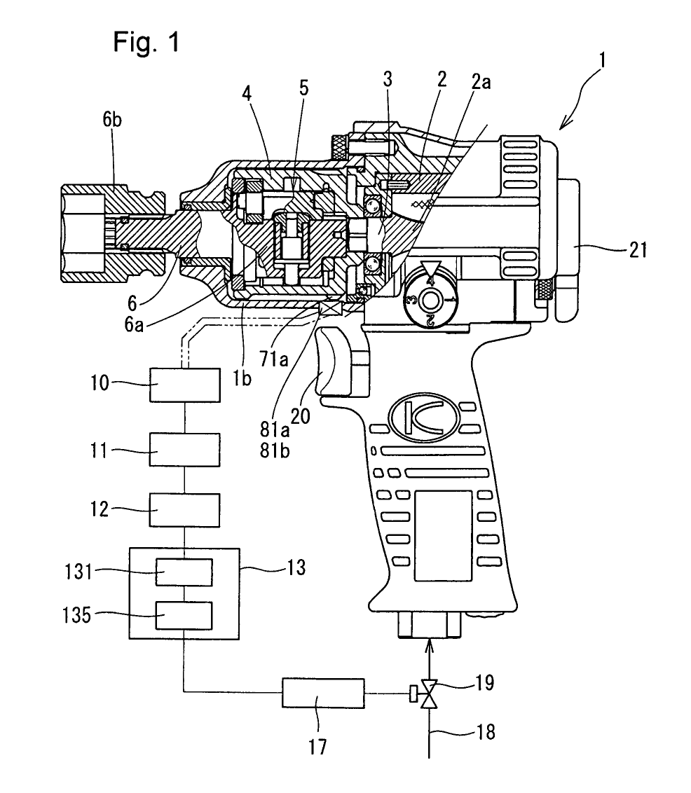

FIG. 1 is a longitudinal sectional side view of a main portion of an impact wrench as an example of the impact wrench to be used in the present invention and a circuit diagram of the main portion.

(Mechanical Structure of Impact Wrench)

In the figure, the reference numeral 1 denotes an impact wrench to be used in the present invention, 2 denotes an air motor provided inside this impact wrench 1, 2a denotes a rotor of the air motor 2, 3 denotes a drive shaft of this air motor 2, and 4 denotes a rotating cylindrical member integrally joined to a front end of the drive shaft 3. A central portion of a disk-shaped rear wall plate of this rotating cylindrical member 4 is integrally joined to the drive shaft 3 by a quadrilateral convex and concave fitting structure.

As generally known, the air motor 2 is rotated clockwise or counterclockwise at a high speed by compressed air by operating an operation lever 20 and a switch lever 21. Then, as generally known, a torque of the rotating cylindrical member 4 that rotates integrally with rotation of the drive shaft 3 of the air motor 2 is transmitted to a driven shaft 6 called an anvil projected forward via a striking power transmission mechanism 5 described later, whereby a screw attached to a socket 6b attached to the tip end of the driven shaft 6 is tightened.

A rear portion of the driven shaft 6 is formed into a large-diameter trunk 6a, and this trunk 6a is provided at a central portion of the rotating cylindrical member 4. The rotating cylindrical member 4 rotates around the trunk 6a of the driven shaft 6 and its torque is transmitted to the driven shaft 6 via the striking power transmission mechanism 5 as described above.

This striking power transmission mechanism 5 includes, as shown in FIG. 2(a), a striking projection 5a projecting inward at an appropriate portion of an inner peripheral surface of the rotating cylindrical member 4, and an anvil piece 5b supported so as to swing to the left and right in a semicircular supporting groove 6b formed above the trunk 6a of the driven shaft 6. Then, in a state that this anvil piece 5b is tilted in the left and right direction, the striking projection 5a is made to collide with an upward one side end face of the anvil piece 5b, whereby the torque of the rotating cylindrical member 4 is transmitted to the driven shaft 6 side.

At the tip end of the anvil piece 5b, as shown in FIG. 2(b), a cam plate 5c is provided. When the cam plate 5c is positioned within a recessed portion 5d with a constant arc length in the circumferential direction provided on a front end inner peripheral surface of the rotating cylindrical member 4, the anvil piece 5b maintains a neutral posture in which it does not engage with the striking projection 5a, and when the cam plate 5c comes out from the recessed portion 5d and moves while being in contact with the inner peripheral surface of the rotating cylindrical member 4, the anvil piece 5b takes a tilting posture in which it collides with the striking projection 5a. By an anvil piece pressing member 5e, a rubber spring 5f, and a spring receiving member 5g provided inside the trunk 6a of the driven shaft 6, a force is always applied to the anvil piece 5b in a direction that makes the anvil piece take the neutral posture. The spring receiving member 5g is in contact with an inner peripheral cam surface 4b of the rotating cylindrical member 4. Furthermore, on the inner peripheral surface of the rotating cylindrical member 4, on both sides of the striking projection 5a, recessed portions 5h which allow the anvil piece 5b to tilt are formed. This structure of the impact wrench is known, so that detailed description thereof is omitted.

(Detecting Rotor and Electronic Control Component)

In FIG. 1, to a rear end outer peripheral surface of the rotating cylindrical member 4, a detecting rotor including a gear with a predetermined number of teeth 71a is fixed integrally. On the other hand, to an inner peripheral surface of a housing 1b on a non-rotating side facing this detecting rotor, a pair of detection sensors 81a and 81b consisting of semiconductor magnetic resistance elements are attached at a predetermined interval in the circumferential direction. The rotation of the detecting rotor is detected by the detection sensors 81a and 81b, and output signals thereof are inputted into an input circuit 10 electrically connected to the detection sensors 81a and 81b.

The signals from the detection sensors 81a and 81b inputted into the input circuit 10 are further inputted into a control section 13 via an amplifier 11 and a waveform shaping section 12.

The control section 13 includes a CPU 131 and a solenoid valve control section 135, and a control signal from the solenoid valve control section 135 is connected to a solenoid valve 19 provided in a compressed air supply hose 18 via an output circuit 17.

(Pulse Signal)

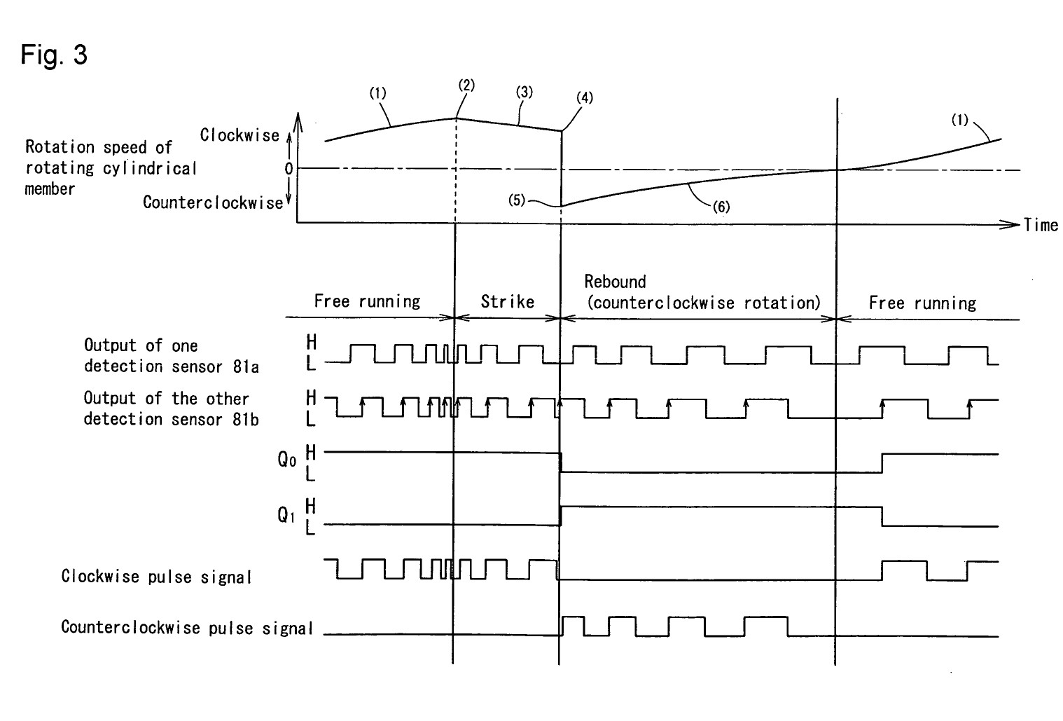

The detection sensors 81a and 81b are constructed so as to output pulse signals with phases mutually different by 90 degrees from each other, so that as the waveforms of these pulse signals, as shown in FIG. 3, when the detecting rotor fixed integrally to the rotating cylindrical member 4 rotates in a screw tightening direction (clockwise rotating direction), from one detection sensor 81a, a pulse signal with a waveform with a phase 90 degrees ahead of that of the other detection sensor 81b is outputted. On the contrary, when the detecting rotor rebounds in the counterclockwise rotating direction together with the rotating cylindrical member 4 after the striking projection 5a collides with the anvil piece 5b and strikes it, the phases of signals from the detection sensors 81a and 81b are inverted. That is, from the other detection sensor 81b, a pulse signal with a waveform with a phase 90 degrees ahead of that of one detection sensor 81a is outputted.

When the detecting rotor rotates in the tightening direction (clockwise rotating direction), if the output waveform from the other detection sensor 81b is up-edge (↑), the waveform from one detection sensor 81a goes high (H), and when the detecting rotor rotates in the rebounding direction (counterclockwise rotating direction), it goes low (L). A detection signal showing this rotating direction is defined as Q₀, and its waveform (H) or (L) is maintained at the high level or low level until the rotating direction changes. On the other hand, a signal Q₁ holds a status completely reverse to that of the signal Q₀. The CPU 131 is constructed so as to detect a pulse signal of the tightening direction (clockwise rotating direction) or rebounding direction (counterclockwise rotating direction) while distinguishing these according to the signal Q₀ or signal Q₁.

Therefore, free running (1) is detected according to a pulse signal (clockwise pulse signal) in the forward rotating direction (tightening direction).

Next, after free running of the rotating cylindrical member 4, at the moment of collision of the striking projection 5a with the anvil piece 5b, the rotation speed of the rotating cylindrical member 4 becomes maximum (2), and from this state, screw tightening in this striking is started. At the time of this tightening, the driven shaft 6 that rotates in the tightening direction consumes energy for screw tightening. Therefore, when screw begins tightening, the rotating cylindrical member 4 that moves integrally with the driven shaft 6 via the striking force transmission mechanism 5 decelerates (3) as shown by a downward-sloping line from the maximum speed (2), and after tightening one time, the rotating cylindrical member 4 rebounds in the counterclockwise direction (6).

As a detection method when starting deceleration (3) from the maximum speed (2), the detection sensors 81a and 81b detect a rotating state of the detecting rotor. That is, during free running of the rotating cylindrical member 4, in accordance with acceleration, the width of the pulse signal detected by the detection sensors 81a and 81b becomes gradually narrower, and at the moment of collision of the striking projection 5a with the anvil piece 5b, the width becomes minimum. Thereafter, the width of the pulse signal in the clockwise direction becomes gradually wider from the start of deceleration of the rotating cylindrical member 4 to the end of striking (rebound start). The pulse whose width becomes gradually narrower and the pulse whose width becomes gradually wider are outputted from the detection sensors 81a and 81b and detected as a clockwise pulse signal in the CPU 131 as described above, and the time when the pulse becomes minimum in width is judged as a screw tightening start point (a time when the rotating cylindrical member is started to decelerate) in this striking.

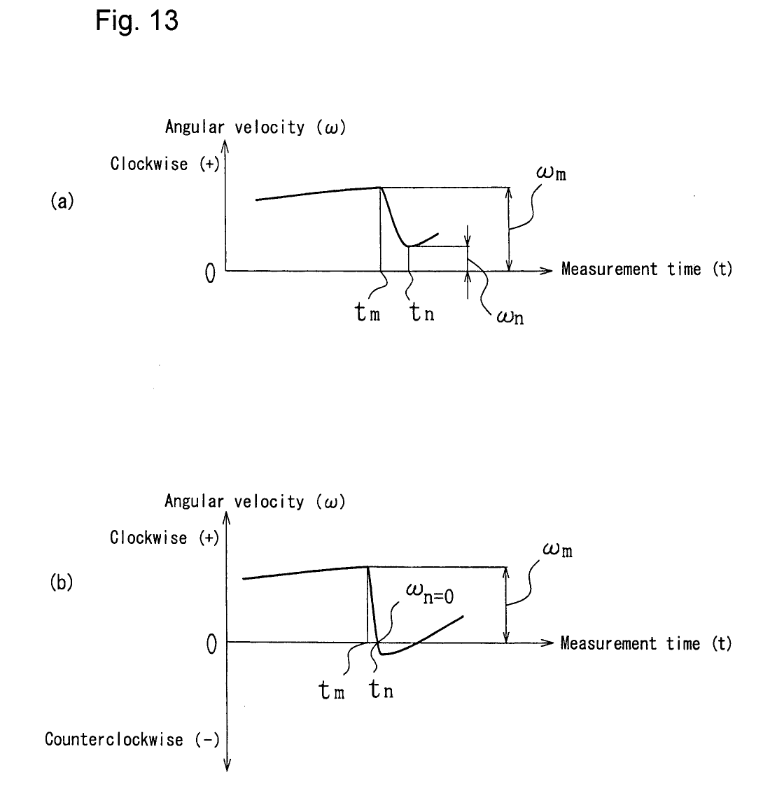

Then, as shown in FIG. 13(a) and FIG. 13(b), the time when the pulse width becomes the minimum pulse width can be regarded as a measurement time tₘ when calculating a dynamic torque. The rotation speed (angular velocity) of the rotating cylindrical member at this time point can be defined as ωₘ.

After thus detecting the deceleration start time point of the rotating cylindrical member 4, during this deceleration (3), in other words, in the period from the deceleration start to the end of striking, the rotation angle of the detecting rotor can be detected by the detection sensors 81a and 81b.

Next, the rotating cylindrical member 4 rebounds (6) in the counterclockwise rotating direction as described above.

At the time when starting this rebound, the rotating direction of the rotating cylindrical member 4 changes from the clockwise rotation to the counterclockwise rotation.

The speed of the rebound (6) of the rotating cylindrical member 4 gradually becomes smaller and it stops, and then the rotating cylindrical member 4 changes its rotating direction to the clockwise direction again according to a torque from the air motor 2, and makes free running (1) while accelerating. Then, the striking projection 5a collides again with the anvil piece 5b, and from the moment of this collision, the rotation speed of the rotating cylindrical member 4 decelerates (3), and the rotation angle of the rotating cylindrical member 4 during deceleration (3) from the deceleration start to the end of striking is detected by the detecting rotor and the detection sensors 81a and 81b in the same manner as described above.

Thereafter, similarly, after free running (1) of the rotating cylindrical member 4, each time of deceleration (3) due to striking, the timing of this deceleration start and the timing of the end of striking can be detected.

Thus, a detection pulse signal is detected each time the teeth 71a of the detecting rotor 71a passes by the pair of detection sensors 81a and 81b, and based on the pulse signal, changes in rotation speed of the rotating cylindrical member 4 can be known.

That is, a series of movements of the rotating cylindrical member 4 in which the rotating cylindrical member starts accelerating from an initial static condition, and after free running, it performs striking, and then rebounds can be detected.

The type of the impact wrench is an impact wrench or an oil pulse wrench, and any of electric or air pressure power may be used. However, it is required that accurate impacting operations and the electromechanical type are essential. Necessities of reading of at least one of the impact information and the axial force calculation function of a polar coordinate system can be pointed out.

### Examples

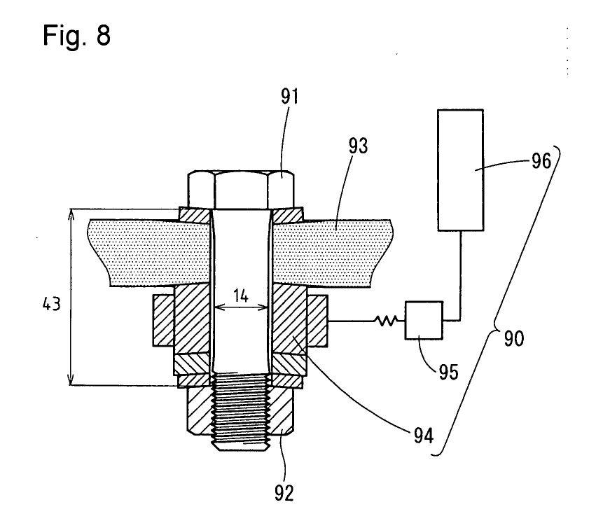

Next, examples will be described.
Sample tightening body: see FIG. 8
Sample screw system:

Hexagon bolt: M14×55 (pitch 2), part classification: A, strength class: 10.9, material: alloy steel

Hexagon nut: M14, part classification: A, material: steel
Spring constant of screw: K=2.618 kN/degree (obtained through conversion after calculating Cb=471.2 kN/mm by using “VDI2230 systematic calculation method of high-strength screw coupling” published by German Engineer's Association)
Spring constant deflection angle α of spring: 20.9 degrees
Tightened material: load cell (thickness: 15 mm) of load cell type axial force sensor, steel plate (thickness: 16 mm), grip length: 43 mm
Lubrication: engine oil applied thinly onto a bearing surface of the hexagon bolt and the hexagon nut, screw surface, and bearing surface of washer.
Impact wrench used: KW-1600pro (made by KUKEN), electromechanical impact wrench, mass 1.4 kg

Anvil tip end shape: spline drive
Impact wrench working condition:

Air pressure when not driven: 0.6 MPa (Pe)

Air hose: φ6.5 mm×3 m

Impact wrench air supply control valve opening: maximum
Tightening target axial force: 70 kN

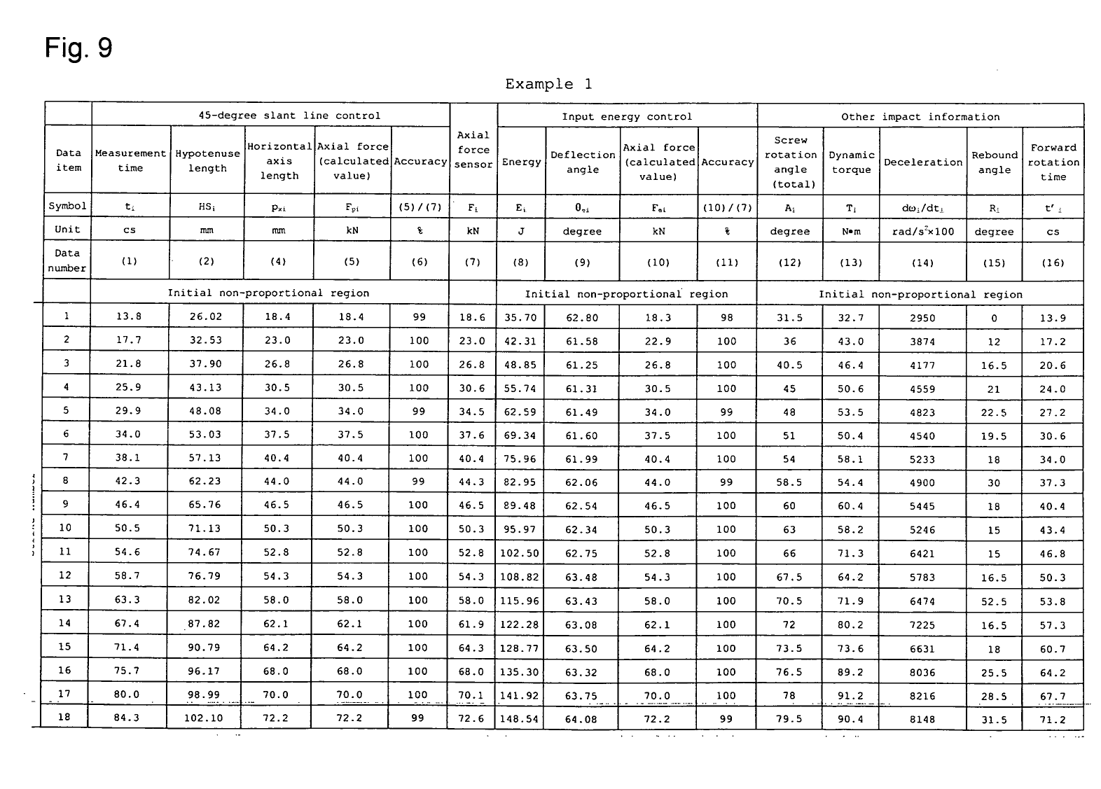

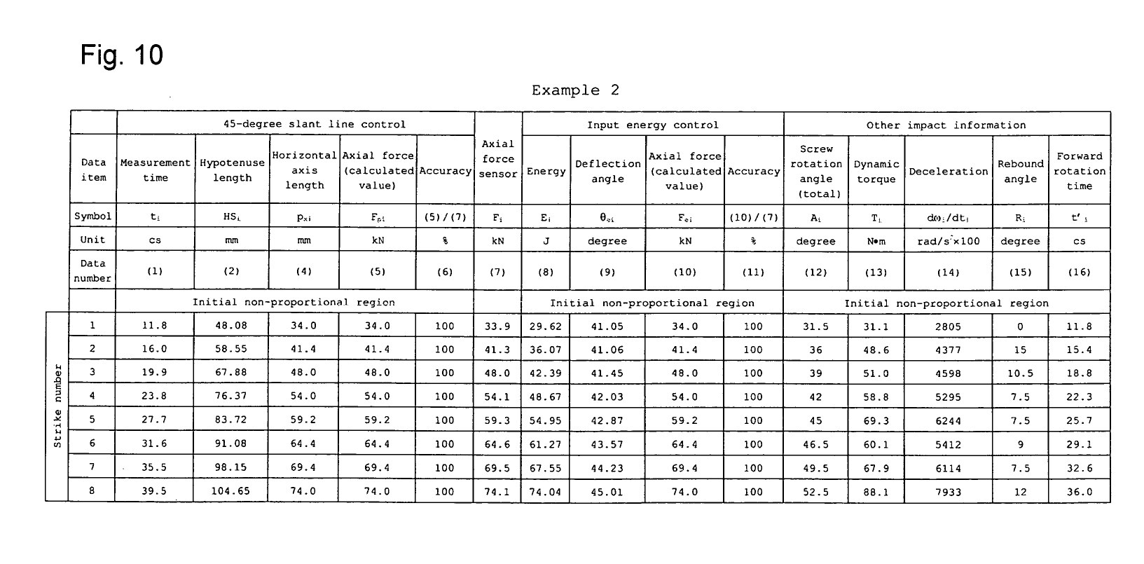

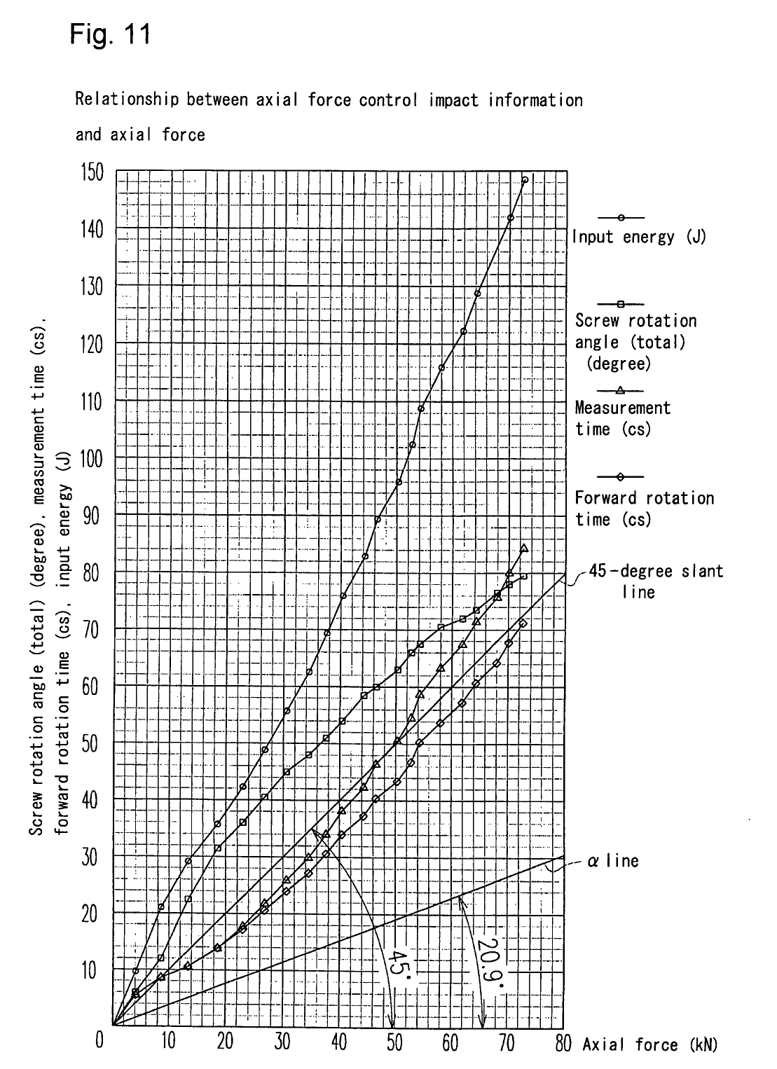

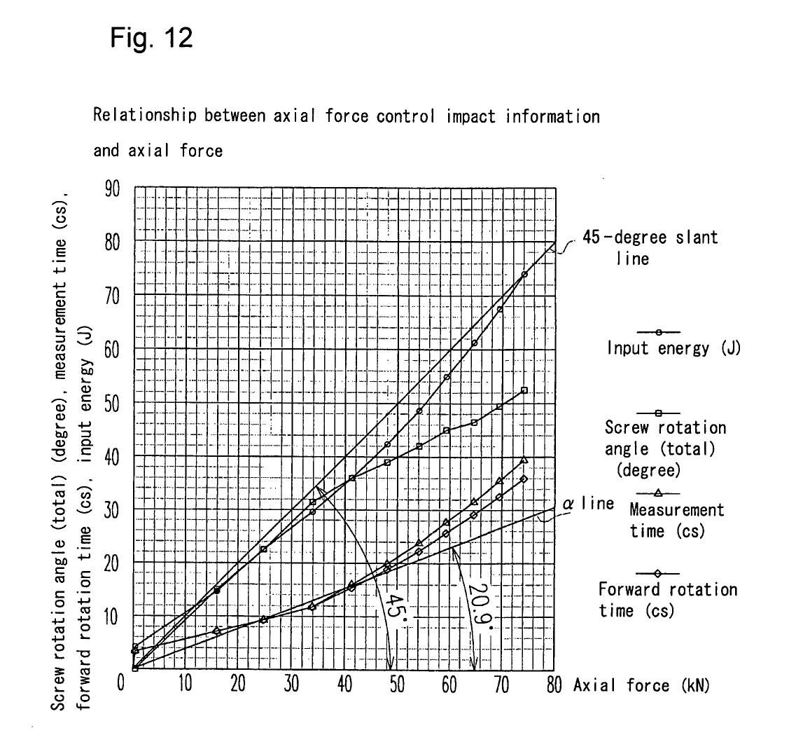

Details of the example experimented under the above-described conditions are summarized and described herein. In the experiment, a screw system (bolt and nut) was subjected to a cycle of tightening and loosening three times from a brand new state, data of the first cycle is shown as Example 1 in the numerical table (FIG. 9), and the graph (FIG. 11), and data of the third cycle is shown as Example 2 in the numerical table (FIG. 10) and the graph (FIG. 12).

This series of experiments did not involve part replacement. In the graphs of FIG. 11 and FIG. 12, impact tightening increases in a phased manner, however, for the sake of convenience, the tightening changes are connected by a broken line.

Generally, each time the screw tightening body is subjected to tightening and loosening, proficiency, conformability, and smoothness of the tightening surface are further improved, and as a result, the ratio of conversion of the tightening input (input energy) into an axial force is increased. Therefore, it is generally regarded as impossible to accurately determine an axial force in the torque control method or angle control method.

The present invention directly controls the axial force, and a torque and a screw rotation angle are regarded as secondary information.

The screw tightening body used in the example is shown in FIG. 8. In this figure, the reference numeral 91 denotes a hexagon bolt, the reference 92 denotes a hexagon nut, the reference 93 denotes a steel plate, the reference 94 denotes a load cell, the reference 95 denotes a switch, and the reference 96 is an arithmetic section. The load cell 94, the switch 95, and the arithmetic section 96 constitute a load cell axial force sensor 90.

In these examples, two kinds of data are simultaneously read from the same tightening work. One is an axial force value measured with a load cell axial force sensor 90 and the other is calculated data obtained from axial force control impact information. This is intended for an aim of the present invention.

In this case, necessary data can be obtained by means of computing with easy, but even such data is obtained through manual calculation at present. The calculated data is shown in the two examples of the 45-degree slant line control method and an input energy control method in Examples 1 and 2, and the accuracy and reliability were verified.

As main numerical values of Examples 1 and 2 shown in the following table (Table 1), an axial force is calculated according to actual circumstances of the tightening surface at the time of screw tightening, and high accuracy was shown in the present invention.

In Examples 1 and 2, the target axial force value is reached at the time of the 18th striking and the 8th striking, so that at these time points, screw tightening was ended. The measurement time of this end point was set as a tightening completion time.

TABLE 1
Main numerical data of Examples

| | Calculated | Force ratio of manupulation | Sensing axial | | Measurement | Striking |
|---|---|---|---|---|---|---|
| Example | axial force | to target | force | Input energy | time | times |
| number | (kN) | (Calculated axial force/70 kN) | (kN) | (J) | (second) | (times) |
| 1 | 72.2 | 1.03 (*) | 72.6 | 148.5 | 0.84 | 18 |
| 2 | 74.0 | 1.06 (*) | 74.1 | 74.0 | 0.40 | 8 |

(*) The accuracy of force ratio measurements can be improved by regulation of impact wrentch performance.

1. A method for controlling screw tightening axial force by use of an impact wrench comprising the steps of:
setting a 45-degree slant line from an origin O of orthogonal coordinate axes to be used for calculating an axial force value;
detecting an impact progress point Hᵢ generated by an i-th impact on the 45-degree slant line;
reading a length HSᵢ of a line segment OHᵢ; and
calculating an axial force value Fᵢ after the i-th impact occurs according to the following formula:
Fᵢ=HSᵢ×cos 45°.

2. A method for controlling screw tightening axial force by use of an impact wrench comprising the steps of:
setting a 45-degree slant line from the origin O of orthogonal coordinate axes to be used for calculating an axial force value;
detecting an impact progress point Hᵢ generated by an i-th impact on the 45-degree slant line and reading an X coordinate value hₓᵢ of Hᵢ; and
calculating an axial force value Fᵢ after the i-th impact occurs according to the following formula:
Fᵢ=hₓᵢ.

3. A method for controlling screw tightening axial force by use of an impact wrench comprising the steps of:
setting a 45-degree slant line from the origin O of orthogonal coordinate axes to be used for calculating an axial force value;
determining an impact line Lᵢ by using at least one of impact information generated by an i-th impact;
obtaining the point Pᵢ of intersection of the 45-degree slant line and the impact line and reading a length PSᵢ of a segment OPᵢ; and
calculating an axial force value Fᵢ after the i-th impact occurs according to the following formula:
Fᵢ=PSᵢ×cos 45°.

4. A method for controlling screw tightening axial force by use of an impact wrench comprising the steps of:
setting a spring constant deflection angle line of a screw and a 45-degree slant line both of which intersect the origin O of the orthogonal coordinates used for calculating an axial force value;
determining an impact line Lᵢ by using at least one of impact information generated by an i-th impact;
obtaining an intersection Pᵢ of the 45-degree slant line and the impact line and reading the value pₓᵢ of the X coordinate thereof; and
calculating an axial force value Fᵢ after the i-th impact occurs according to the following formula:
Fᵢ=pₓᵢ×tan α×K
wherein α denotes a deflection angle between the spring constant deflection angle line of the screw and the horizontal axis, and
K denotes a spring constant of the screw expressed by (axial force)/(screw rotation angle (elongation)).

5. A method for controlling screw tightening axial force by use of an impact wrench comprising the steps of:
setting a spring constant deflection angle line of a screw from the origin O of orthogonal coordinate axes to be used for calculating an axial force value;
determining an impact line Lᵢ by using at least one of impact information generated by an i-th impact; and
reading a value gₓᵢ of an X coordinate and a value g_{yi} of a Y coordinate of a detection point Gᵢ concerning any one of detected impact information, where
a deflection angle θ_{gi} between a line segment connecting the origin O and the detection point Gᵢ and the horizontal axis can be expressed by the following formula:
θ_{gi}=tan⁻¹(g_{yi}/gₓᵢ)
and calculating an axial force value Fᵢ after the i-th impact occurs according to the following formula:
Fᵢ=g_{yi}/tan θ_{gi}.

6. A method for controlling screw tightening axial force by use of an impact wrench comprising the steps of:
setting a spring constant deflection angle line of a screw from an origin O of orthogonal coordinate axes to be used for calculating an axial force value;
determining an impact line Lᵢ by using at least one of impact information generated by the i-th impact:
reading a value gₓᵢ of an X coordinate of a detection point Gᵢ concerning any one of the detected impact information; and
calculating an axial force value Fᵢ after an i-th impact occurs according to the following formula:
Fᵢ=gₓᵢ×tan α×K.

7. A method for controlling elastic screw tightening by use of an impact wrench comprising the steps of:
setting a spring constant deflection angle line of a screw from the origin O of orthogonal coordinate axes;
determining an impact line Lᵢ by using at least one of impact information generated by the i-th impact;
obtaining an intersection Bᵢ of the spring constant deflection angle line of the screw and the impact line, and reading a value aᵢ of the Y coordinate thereof; and
calculating output energy Eₒᵢ transmitted to a screw tightening body after the i-th impact occurs according to the following formula:
Eₒᵢ=1/2×C×K×(aᵢ)²
wherein C is a conversion coefficient expressed as (screw pitch)/360.
